(19) United States
(12) Patent Application Publication
(10) Pub. No.: US 2007/0129116 A1
(43) Pub. Date: Jun. 7, 2007

(54) On-vehicle hands-free device and system

(75) Inventors: Daisuke Katoh, Nukata-gun (JP); Naoki Matsuda, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/633,683

(22) Filed: Dec. 4, 2006

(30) Foreign Application Priority Data
Dec. 5, 2005 (JP) 2005-350570

(51) Int. Cl. H04M 1/00

(52) U.S. Cl. 455/569.1

(57) ABSTRACT

An on-vehicle hands-free system includes an on-vehicle hands-free device that is communicable with a cell phone under both a hands-free profile and other profiles. When a stop trigger is generated by an external switch such as an accessory switch under a condition that the hands-free device is communicable under any of the other profiles, this profile other than the hands-free profile is automatically disconnected so that the hands-free device starts its operation in a normal wait state if a start trigger for starting communication is generated again. Thus, communication with the cell phone under the hands-free profile can be started in a short time after the start trigger.

### CROSS REFERENCE TO RELATED APPLICATION

This application is based on and incorporates herein by reference Japanese Patent Application No. 2005-350570 filed on Dec. 5, 2005.

### FIELD OF THE INVENTION

The present invention relates to an on-vehicle hands-free device that is capable of communicating with a mobile communication device such as a cell phone under not only a hands-free profile but also other profiles, and also relates to an on-vehicle hands-free system that includes such an on-vehicle hands-free device and a mobile communication device.

### BACKGROUND OF THE INVENTION

In an on-vehicle hands-free device that performs Bluetooth (trademark) communication as disclosed in US 2005/0070338 A1 (JP 2005-110049A), when a start trigger is generated by turning on of an accessory switch of a vehicle for instance, a hands-free communication is automatically enabled to be performed with a Bluetooth cell phone by being connected to a hands-free profile or protocol (HFP) if it is possible to perform the Bluetooth communication with such a Bluetooth cell phone at that time.

However, a stop trigger is sometimes generated by turning off of the accessory switch under a condition that the hands-free device is in the state of being communicable with the Bluetooth cell phone under a different profile (e.g., a dial-up network profile DUNP) other than the hands-free profile. When the start trigger is generated again immediately after the stop trigger, the Bluetooth cell phone is not put in a normal wait state that is for operating under any one of profiles but continuously put in a different wait state that is for waiting for processes of such a profile. In this case, it takes some time for the hands-free device to connect to the hands-free profile and become communicable with the Bluetooth cell phone under the hands-free profile. As a result, the hands-free communication cannot be started in a short time.

### SUMMARY OF THE INVENTION

It is therefore an object of the present invention to provide an on-vehicle hands-free device and an on-vehicle hands-free system, that enable hands-free communication in a short time after a start trigger is generated.

According to one aspect of the present invention, an on-vehicle hands-free device for communication with a mobile communication device comprises an on-vehicle wireless communication unit and a control unit. The wireless communication unit is communicable with the mobile communication device under a hands-free profile and other profiles different from the hands-free profile. When a stop trigger for stopping communication with the mobile communication device is detected, the control unit forcibly disconnects the other profile thereby to disable the mobile communication device to communicate under the other profile, if the wireless communication unit is communicable with the mobile communication device under the other profile at that time.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an embodiment of on-vehicle hands-free device and system according to the present invention; and

FIG. 2 is a flow diagram showing processing of the on-vehicle hands-free device.

### DETAILED DESCRIPTION OF THE EMBODIMENT

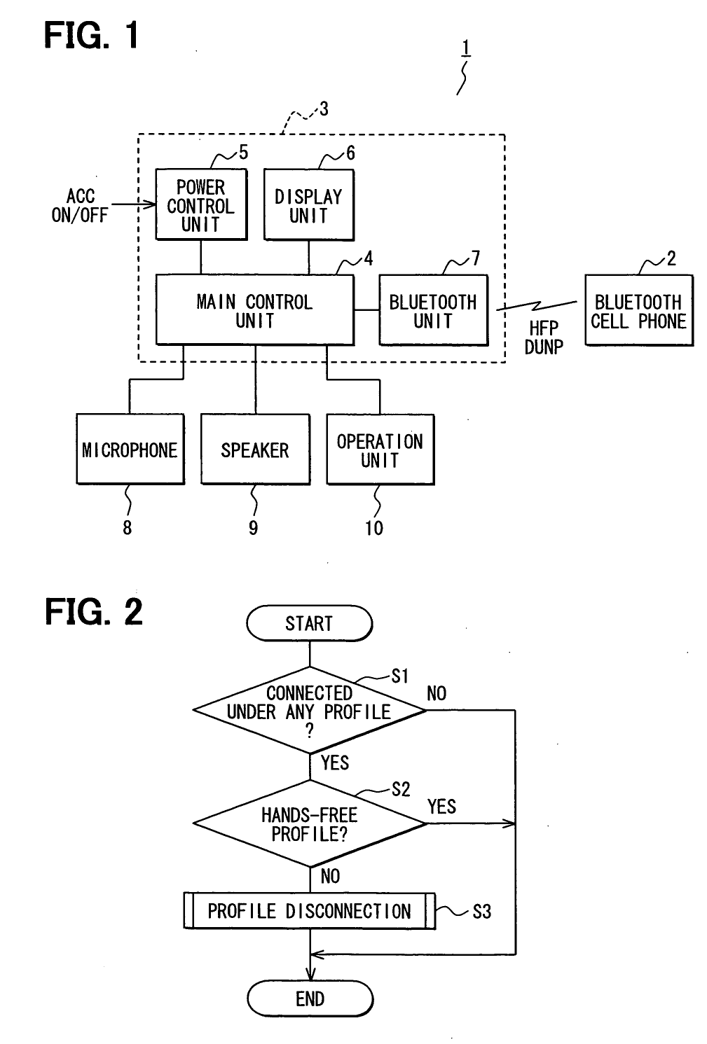

Referring to FIG. 1, an on-vehicle hands-free system 1 is formed by a Bluetooth cell phone 2, which is a mobile communication device, and an on-vehicle hands-free device 3. Both the cell phone 2 and the hands-free device 3 are capable of Bluetooth communication (short-distance wireless communication) with each other. Specifically, the cell phone 2 is capable of performing Bluetooth communication with the hands-free device 3 if it is powered on and in a Bluetooth communication area. The cell phone 2 is also capable of cellular communication with other cell phones and fixed-line phones through cellular phone networks.

The hands-free device 3 is constructed with a main control unit 4, a power control unit 5, a display unit 6 and a Bluetooth unit 7. The main control unit 4 includes CPU, RAM, ROM, etc. and controls entire operations of the hands-free device 3.

The power control unit 5 is connected to an accessory switch (not shown) of a vehicle to receive a start trigger and a stop trigger when the accessory switch is turned on and off (ACC ON/OFF), respectively. The power control unit 5 is constructed to be operable to monitor application of an ACC ON signal and an ACC OFF signal with low electric power, even when power supply to the hands-free device 3 are in the OFF condition. When the start trigger (ACC ON) is applied, the power control unit 5 starts electric power supply to the main control unit 4 to thereby enable other units in the hands-free device 3 to operate. On the other hand, when the stop trigger (ACC OFF) is applied, the power control unit 5 stops electric power supply to the main control unit 4 to thereby disable the other units in the hands-free device 3 to continue to operate.

The display unit 6 displays various images and information in response to display command signals applied from the main control unit 4. The Bluetooth unit 7 performs Bluetooth communication operations in response to operation command signals applied from the main control unit 4. The Bluetooth unit 7 is constructed to be communicable with the Bluetooth cell phone 2 under a hands-free profile (HFP) that is a protocol required for the main control unit 4 to perform hands-free communication processing. The Bluetooth unit 7 is also constructed to be communicable with the Bluetooth cell phone 2 under other profiles than the hands-free profile. The other profiles may include a dial-up network profile (DUNP) that is a protocol required for the main control unit 4 to perform data communication processing.

When the Bluetooth unit 7 is communicable with the cell phone 2 under the hands-free profile, that is, the Bluetooth unit 7 is connected to the hands-free profile with the cell phone 2, the main control unit 4 causes voice sound signals received from a microphone 8 to be transmitted from the Bluetooth unit 7 to the cell phone 2 and also causes voice sound signals transmitted from the cell phone 2 to the Bluetooth unit 7 to be produced from a speaker 9. When any operation signals are applied from the operation unit 10, the main control unit 4 causes corresponding operations, which a user instructed by the operation signals. The hands-free device 3 may be integrated with an on-vehicle navigation device (not shown), so that the navigation device may perform the Bluetooth communication with the cell phone 2.

The operation of the system 1 will be described below with reference to a flow diagram shown in FIG. 2, which the main control unit 4 is programmed to execute as a part of its processing.

In the hands-free device 3, when the main control unit 4 detects that the stop trigger (ACC OFF signal of the accessory switch) is applied to the power control unit 5, the main control unit 4 checks at step S1 whether the Bluetooth unit 7 is connected to any of communication profiles, that is, whether the Bluetooth unit 7 is communicable with the cell phone 2 under a certain communication profile. If the determination result at step S1 is YES indicating that the Bluetooth unit 7 is connected to the cell phone 2, the main control unit 4 further checks at step S2 whether the profile is the hands-free profile. If the determination result of step S2 is NO indicating that the connecting profile is other than the hands-free profile, the main control unit 4 performs a disconnection process to disconnect the Bluetooth unit 7 from the connecting profile at step S3. Thus, the Bluetooth unit 7 is put in the state of being not communicable with the cell phone 2 under such as profile other than the hands-free profile.

If the determination results at step S1 and S2 are NO and YES indicating that the Bluetooth unit 7 is not in the state of being communicable under any profiles or is in the state of being communicable under the hands-free profile, respectively, the main control unit 4 ends the processing of FIG. 2.

According to the above operation, each time the stop trigger is applied, any profiles other than the hands-free profile are disconnected forcibly and automatically. Therefore, when the hands-free device 2 is activated next time by turning on the accessory switch (start trigger by ACC ON), the cell phone 2 is put in the normal wait state for being connected under any of the profiles without being put in the other wait state for continuing to wait for processes of other profiles than the hands-free profile. Thus, the hands-free communication can be started shortly after the hands-free device 2 is activated.

In the above embodiment, the stop trigger may be generated by any other switches, for instance, by a stop button switch if provided on the hands-free device 2. The profiles other than the hands-free profile may include an object push profile (OPP), a basic image profile (BIP) or the like.

What is claimed is:

1. An on-vehicle hands-free device for communication with a mobile communication device, the hands-free device comprising:
a wireless communication means communicable with the mobile communication device under a hands-free profile and an other profile different from the hands-free profile;
a stop trigger detecting means that detects a stop trigger for stopping communication with the cell phone; and
a control means that forcibly disconnects, when the communication means is communicable with the mobile communication device under the other profile at a time of detecting the stop trigger by the detecting means, the other profile thereby to disable the mobile communication device to communicate under the other profile.

2. An on-vehicle hands-free system comprising:
a mobile communication device that is communicable under a hands-free profile and an other profile different from the hands-free profile; and
an on-vehicle hands-free device that is capable of a wireless communication with the cell phone,
wherein the hands-free device includes
a wireless communication means communicable with the mobile communication device under the hands-free profile and the other profile,
a stop trigger detecting means that detects a stop trigger for stopping communication with the mobile communication device, and
a control means that forcibly disconnects, when the communication means is communicable with the mobile communication device under the other profile at a time of detecting the stop trigger by the detecting means, the other profile thereby to disable the mobile communication device to communicate with the mobile communication device under the other profile.
